(19) United States
(12) Patent Application Publication
(10) Pub. No.: US 2025/0077871 A1
(43) Pub. Date: Mar. 6, 2025

(54) PRIVACY-SENSITIVE NEURAL NETWORK TRAINING

(71) Applicant: Google LLC, Mountain View, CA (US)

(72) Inventors: Devora Berlowitz, Seattle, WA (US); Steve Shaw-Tang Chien, San Carlos, CA (US); Yunqi Xue, Mountain View, CA (US); Lin Ning, San Jose, CA (US); Shuang Song, Cupertino, CA (US); Mei Chen, Sunnyvale, CA (US)

(21) Appl. No.: 18/564,160

(22) PCT Filed: May 25, 2023
(86) PCT No.: PCT/US2023/023465

§ 371 Date: Nov. 27, 2023

(30) Foreign Application Priority Data
Jun. 26, 2022 (IL) 294292

(51) Int. Cl. G06N 3/084

(52) U.S. Cl. CPC G06N 3/084

(57) ABSTRACT

Methods, systems, and apparatus, including computer programs encoded on a computer storage medium, for privacy-sensitive training of a neural network. In one aspect, a system comprises a central memory configured to store current values of a set of neural network parameters and one or more computers that are configured to implement a plurality of worker computing units, where each worker computing unit is configured to repeatedly perform operations comprising obtaining current values of the set of neural network parameters from the central memory, sampling a batch of network inputs from a set of training data, determining a respective gradient corresponding to each network input, determining an aggregated gradient based on the gradients, identifying a subset of a set of gradient values as target values, generating a noisy gradient by combining random noise with the target gradient values, and updating the current values of the set of neural network parameters.

### CROSS-REFERENCE TO RELATED APPLICATION

This application claims priority to Israeli Application No. 294292, filed on Jun. 26, 2022, the entire contents of which are hereby incorporated by reference in their entirety.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that performs privacy-sensitive training of a neural network.

Throughout this specification, a computing unit (e.g., a worker computing unit) may be, e.g., a computer, a core within a computer having multiple cores, or other hardware or software, e.g., a dedicated thread, within a computer capable of independently performing operations. The computing units may include processor cores, processors, microprocessors, special-purpose logic circuitry, e.g., an FPGA (field-programmable gate array) or an ASIC (application-specific integrated circuit), or any other appropriate computing units. In some examples, the computing units are all the same type of computing unit. In other examples, the computing units may be different types of computing units. For example, one computing unit may be a CPU while other computing units may be GPUs.

According to one aspect, there is provided a system for privacy-sensitive training of a neural network having a set of neural network parameters, the system comprising a central memory that is configured to store current values of the set of neural network parameters and one or more computers that are configured to implement a plurality of worker computing units, wherein each worker computing unit is configured to repeatedly perform operations comprising obtaining current values of the set of neural network parameters from the central memory; sampling a batch of network inputs from a set of training data; determining a respective gradient corresponding to each network input, comprising, for each network input: processing the network input using the neural network, in accordance with current values of the set of neural network parameters, to generate a network output; and determining a gradient of an objective function with respect to the set of neural network parameters when the objective function is evaluated on the network output; determining an aggregated gradient based on the gradients corresponding to the network inputs; identifying a proper subset of a set of gradient values included in the aggregated gradient as target gradient values to be combined with random noise; generating a noisy gradient by combining random noise with the target gradient values in the aggregated gradient; and updating the current values of the set of neural network parameters stored in the central memory using the noisy gradient.

In some implementations, determining the gradient corresponding to the network input comprises clipping the gradient corresponding to the network input based on a predefined clipping threshold.

In some implementations, clipping the gradient corresponding to the network input based on the predefined clipping threshold comprises scaling the gradient to cause a norm of the gradient to satisfy the predefined clipping threshold.

In some implementations, the aggregated gradient is defined by a sparse array of numerical values.

In some implementations, the noisy gradient is defined by a sparse array of numerical values.

In some implementations, identifying the proper subset of the set of gradient values included in the aggregated gradient as target gradient values to be combined with random noise comprises identifying a set of non-zero gradient values in the aggregated gradient; and selecting a gradient value in the aggregated gradient as a target gradient value only if the gradient value is included in the set of non-zero gradient values in the aggregated gradient.

In some implementations, generating the noisy gradient by combining random noise with the target gradient values in the aggregated gradient comprises, for each target gradient value in the aggregated gradient, adding a respective random noise value to the target gradient value.

In some implementations, the random noise value is sampled from a Gaussian distribution.

In some implementations, determining the aggregated gradient based on the gradients corresponding to the network inputs comprises generating the aggregated gradient as an average of the gradients corresponding to the network inputs.

In some implementations, for each network input, determining the gradient of the objective function with respect to the set of neural network parameters when the objective function is evaluated on the network output comprises backpropagating the gradient of the objective function through the set of neural network parameters.

In some implementations, updating the current values of the set of neural network parameters stored in the central memory using the noisy gradient comprises updating the current values of the set of neural network parameters using the noisy gradient by a gradient descent update rule.

In some implementations, the neural network is configured to receive a network input that includes features values of a categorical feature, wherein the set of neural network parameters define a respective embedding corresponding to each possible value of the categorical feature.

In some implementations, the neural network comprises an embedding layer that is configured to map each categorical feature value included in the network input to a corresponding embedding.

In some implementations, the categorical feature has at least 100,000 possible categorical feature values.

In some implementations, the neural network is configured to receive a network input includes feature values of the categorical feature that characterize a previous search query of a user, and the neural network is configured to generate a network output that characterizes a predicted next search query of the user.

In some implementations, the neural network is configured to receive a network input that includes feature values of the categorical feature that characterize previous videos watched by a user, and the neural network is configured to generate a network output that characterizes a predicted next video watched by the user.

In some implementations, the neural network is configured to receive a network input that includes feature values of the categorical feature that characterize previous webpages visited by a user, and the neural network is configured to generate a network output that characterizes a predicted next webpage visited by the user.

In some implementations, the neural network is configured to receive a network input that includes feature values of the categorical feature that characterizes previous products associated with a user, and the neural network is configured to generate a network output that characterizes a predicted next product associated with the user.

According to another aspect, there are provided one or more computer storage media storing instructions that when executed by one or more computers cause the one or more computers to perform operations for privacy-sensitive training of a neural network having a set of neural network parameters, the operations comprising the operations of the described system.

According to another aspect, there is provided a method performed by one or more computers for privacy-sensitive training of a neural network having a set of neural network parameters, the method comprising the operations of the described system.

Particular embodiments of the subject matter described in this specification can be implemented so as to realize one or more of the following advantages.

The training system described in this specification can train a neural network to perform a machine learning task using a privacy-sensitive training technique that mitigates the risk of privacy attacks, and increases security of the neural network. A privacy attack on a neural network can refer to operations performed to extract information about the training data used to train the neural network, e.g., in the form of revealing individual training examples (e.g., including individual network inputs) that were used during the training of the neural network. Privacy attacks can result in the exposure of confidential information. The risk of privacy attacks, if left unaddressed, can limit the deployment of machine learning models that are trained on sensitive datasets.

The training system implements privacy-sensitive training, e.g., by combining noise with gradients prior to using the gradients to update the set of neural network parameters. The training system can train the neural network in a distributed fashion, with a central memory hosting the current values of the set of neural network parameters, and a collection of worker computing units accessing the parameters from the central memory and performing training jobs. Each worker computing unit can compute gradients locally and send the gradients back to the central memory. In some cases, the gradients computed by the worker computing units are sparse (e.g., having mostly zero values) and the worker computing units thus only need to send a small amount of data to transmit the gradients to the central memory. However, combining noise with the gradients as part of privacy-sensitive training can cause the previously sparse gradients to become dense. The resulting extra traffic between the worker computing units and the central memory and the extra computational cost can significantly slow down the training speed, making it difficult or even prohibitive to train the neural network.

To address this issue, the training system only combines noise with a selected proper subset of a set of gradient values included in the gradients, thus maintaining the sparsity of the gradients and eliminating the slowdown caused by using dense gradients. For example, the training system can be configured to combine noise with a gradient value only if the gradient value is non-zero, thus maintaining the sparsity of the gradients.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system.

FIG. 2 is a block diagram of an example neural network system.

FIG. 3 is a block diagram of an example gradient system.

FIG. 4 illustrates an array of gradient values for an aggregated gradient and demonstrates random noise insertion.

FIG. 5 is a flow diagram of an example process for privacy-sensitive training of a neural network having a set of neural network parameters.

FIG. 6 is a flow diagram of an example process for generating a noisy gradient from an aggregated gradient.

Like reference numbers and designations in the various drawings indicate like elements.

### DETAILED DESCRIPTION

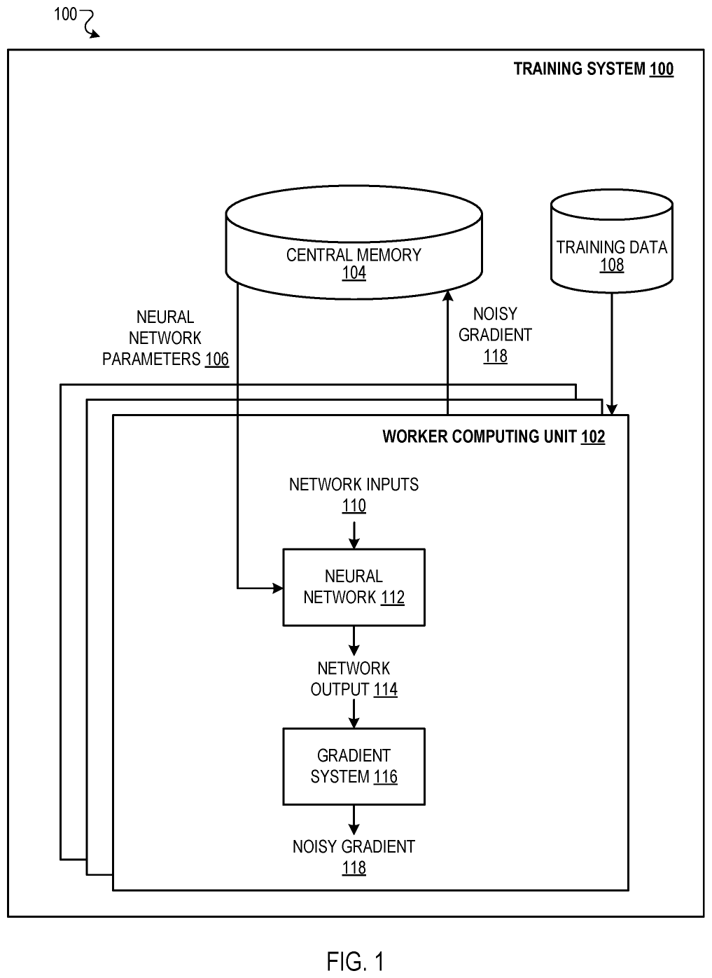

FIG. 1 shows an example training system 100. The training system 100 is an example of a system implemented as computer programs on one or more computers in one or more locations in which the systems, components, and techniques described below are implemented.

The training system 100 is configured to train a neural network to perform a machine learning task using a privacy-sensitive training technique that mitigates the risk of privacy attacks.

The neural network can include any appropriate types of neural network layers (e.g., embedding layers, fully connected layers, attention layers, convolutional layers, etc.) in any appropriate number (e.g., 5 layers, 10 layers, or 100 layers) and connected in any appropriate configuration (e.g., as a directed graph of layers).

The neural network can be configured to process a network input that includes feature values of one or more categorical features to generate a corresponding network output. The network input may include zero, one, or multiple possible feature values of each categorical feature.

The neural network can include an embedding neural network layer that is configured to receive the network input and to instantiate a respective embedding corresponding to each of the categorical feature values included in the network input. In particular, the embedding layer can be parameterized by a set of embedding layer parameters that define a respective embedding corresponding to each possible categorical feature value. The embedding layer can map each categorical feature value included in the network input onto a corresponding embedding defined by the set of embedding layer parameters of the embedding layer. The embedding layer can then provide the embeddings of the categorical feature values included in the network input to one or more subsequent layers of the neural network. The subsequent layers of the neural network can process the embeddings of the categorical feature values, in accordance with values of a set of non-embedding layer parameters, to generate a network output.

Generally, the neural network can perform any of a variety of machine learning tasks. A few examples of possible machine learning tasks that may be performed by the neural network are described in more detail next.

In one example, the neural network may be configured to process an input that characterizes a previous textual search query of a user to generate an output that specifies a predicted next search query of the user. The categorical features in the input to the neural network may include, e.g.: the previous search query, uni-grams of the previous search query, bi-grams of the previous search query, and tri-grams of the previous search query. A n-gram (e.g., uni-gram, bi-gram, or tri-gram) of a search query refers to a sequence of n consecutive characters in the search query. The possible feature values of the “previous search query” categorical feature may include a predefined set of possible search queries, e.g., 1 million possible search queries, or any other appropriate number of possible search queries. The possible feature values of each “n-grams of the previous search query” categorical feature may include a predefined set of possible n-grams. The output of the neural network may include a respective score for each search query in a set of multiple possible search queries, where the score for each search query characterizes a likelihood that it will be the next search query of the user. This can help with pre-loading of desired search results and providing faster access to results.

In another example, the neural network may be configured to process an input that characterizes a software application to generate an output that defines a likelihood that the software application will be selected by a user to be installed on a user device (e.g., a smartphone). The categorical features in the input to the neural network may include, e.g., an application identifier categorical feature, an application developer categorical feature, and an application title categorical feature. The possible feature values of the application identifier categorical feature may include a predefined set of possible application identifiers (e.g., represented as integer values), where each application identifier corresponds to a respective application. The possible feature values of the application developer categorical feature may include a predefined set of possible application developers. The possible feature values of the application title categorical feature may include a predefined set of possible n-grams.

In another example, the neural network may be configured to process an input that characterizes previous videos watched by a user to generate an output that characterizes a predicted next video to be watched by the user (e.g., on a video-sharing platform). The categorical features in the input to the neural network may include a categorical feature specifying identifiers (IDs) of the previous videos watched by the user, where the possible feature values of the categorical feature include a respective ID corresponding to each of multiple videos. The output of the neural network may include a respective score for each video in a set of multiple videos, where the score for each video characterizes a likelihood that it is the next video to be watched by the user. This has a benefit of facilitating the pre-loading/buffering of a video to provide faster access.

In another example, the neural network may be configured to process an input that characterizes previous webpages visited by a user to generate an output that characterizes a predicted next webpage to be visited by the user. The categorical features in the input to the neural network may include a categorical feature specifying IDs of previous websites visited by the user, where the possible feature values of the categorical feature include a respective ID corresponding to each of multiple webpages. The output of the neural network may include a respective score for each webpage in a set of multiple webpages, where the score for each webpage characterizes a likelihood that it is the next webpage to be visited by the user. This has a benefit of pre-loading a webpage to provide a faster webpage delivery experience.

In another example, the neural network may be configured to process an input that characterizes products associated with a user, e.g., products that were previously purchased by the user, or products that the user previously viewed on an online platform, to generate an output that characterizes other products that may be of interest to the user. The categorical features in the input to the neural network may include a categorical feature specifying IDs of products associated with the user, where the possible feature values of the categorical feature include a respective ID corresponding to each of multiple products. The output of the neural network may include a respective score for each product in a set of multiple products, where the score for each product characterizes a likelihood that the product is of interest to the user (e.g., should be recommended to the user).

In another example, the neural network may be configured to process an input that characterizes digital components associated with a user, e.g., digital components that were previously transmitted to the user, to generate an output that characterizes other digital components that may be of interest to the user. The categorical features in the input to the neural network may include a categorical feature specifying IDs of digital components that were previously transmitted to the user, where the possible feature values of the categorical feature include a respective ID corresponding to each of multiple digital components. The output of the neural network may include a respective score for each digital component in a set of multiple digital components, where the score for each digital component characterizes a likelihood that the digital component is of interest to the user (e.g., such that the digital component should be transmitted to the user and the resources associated with such transmission would not be wasted on a different, undesired component).

In another example, the neural network may be configured to process an input that characterizes a sequence of text message between a first user and a second user to generate an output that characterizes a reply message from the first user to the second user. The neural network can be configured to process network inputs that include tokens representing the sequence of text messages, such as “incoming message 1, reply 1, incoming message 2, reply 2, incoming message 3.” The output of the neural network may include suggested replies to a previous message of the second user, such as “reply 3,” which is a suggested reply to “incoming message 3.” The output of the neural network may further include a respective score for each suggested reply in a set of suggested replies, where the score for each product characterizes a likelihood that the suggested reply is useful to the first user (e.g., should be recommended to the first user).

As used throughout this specification, the phrase digital components refers to discrete units of digital content or digital information that can include one or more of, e.g., video clips, audio clips, multimedia clips, images, text segments, or uniform resource locators (URLs). A digital component can be electronically stored in a physical memory device as a single file or in a collection of files, and digital components can take the form of video files, audio files, multimedia files, image files, or text files and include streaming video, streaming audio, social network posts, blog posts, and/or advertising information, such that an advertisement is a type of digital component. Generally, a digital component is defined by (or provided by) a single provider or source (e.g., an advertiser, publisher, or other content provider), but a digital component provided from one source could be enhanced with data from another source (e.g., weather information, real time event information, or other information obtained from another source).

The training system 100 includes a central memory 104, a set of training data 108, and a set of multiple worker computing units 102, which are each described in more detail next.

The central memory 104 is configured to store current values of a set of neural network parameters of the neural network being trained by the training system 100. The set of neural network parameters of the neural network can include any appropriate number of parameters, e.g., 1 million, 100 million, or 1 billion parameters. The set of neural network parameters can include a set of embedding layer parameters of the embedding layer of the neural network, and a set of non-embedding layer parameters (i.e., the parametrize the remainder of the neural network other than the embedding layer(s)). In some cases, the number of embedding layer parameters can exceed the number of non-embedding layer parameters, e.g., by one or more order or magnitude. That is, the set of embedding layer parameters can constitute the bulk of the parameters of the neural network.

The central memory 104 can be implemented by one or more parameter servers. In some cases, the central memory 104 includes multiple parameter servers, where each parameter server stores a respective subset of the set of neural network parameters of the neural network.

The set of training data 108 can include multiple training examples. Each training example can include a network input to the neural network and data characterizing a target output that should be generated by the neural network by processing the network input.

The set of training data can include any appropriate number of training examples, e.g., 1 thousand training examples, 100,000 training examples, or 1 million training examples. In some cases, some or all of the training examples may include private data, e.g., data characterizing individual users. The training system 100 operates to maintain the privacy of the training data by mitigating the risk of privacy attacks on the neural network, as described throughout this specification.

The one or more worker computing units 102 can operate synchronously or asynchronously. The training system 100 can include any appropriate number of worker computing units 102, e.g., 5 worker computing units, 50 worker computing units, or 500 worker computing units.

Each worker computing unit 102 is configured to train the neural network by iteratively updating the current values of the set of neural network parameters stored in the central memory 104. To this end, each worker computing unit 102 includes a local copy of the neural network 112 and a gradient system 116, which are each described in more detail next.

The training system 100 can use a noisy gradient 118 generated by the gradient system 116 of a worker computing unit to update the neural network parameters 106 stored in the central memory 104. The training system can train the neural network until a termination criterion is satisfied. The termination criterion can be that the neural network, when parameterized by the parameter values stored in the central memory 104, achieves at least a threshold level of performance on a held-out set of validation data.

At each of multiple training iterations, each worker computing unit 102 accesses the central memory 104 to obtain the current values of the neural network parameters 106. The worker computing unit 102 then uses the neural network parameters 106 to parametrize the local copy of the neural network 112.

Further, the worker computing unit 102 samples a batch of training examples from the set of training data 108. Each training example can include a network input 110 to the neural network 112 and a corresponding target output of the neural network, as described above. The worker computing unit 102 can sample the batch of training examples, e.g., by randomly sampling a predefined number of training examples from the set of training data 108.

The worker computing unit 102 can process the network input 110 from each training example in the batch of training examples using the neural network 112 and in accordance with the current values of the set of neural network parameters 106 (as obtained from the central memory 104) to generate a corresponding network output 114.

The gradient system 116 of the worker computing unit 102 is configured to process the network outputs 114 generated by the neural network 112 for the network inputs 110 from current batch of training examples to generate a noisy gradient 118. The noisy gradient 118 can include a respective gradient value for each of parameter in the set of neural network parameters 106. The training system 100 can use the noisy gradient 118 to update the current values of the set of neural network parameters 106 stored in the central memory 104, as will be described in more detail below.

The gradient system 116 is configured to generate the noisy gradient 118 in a manner that mitigates the risk of privacy attacks on the neural network. A privacy attack on a neural network can refer to operations performed to extract information about the training data used to train the neural network, e.g., in the form of revealing individual training examples (e.g., including individual network inputs) that were used during the training of the neural network, which can result in the exposure of confidential information. To mitigate the risk of a privacy attack, and hence increase the security of the neural network, the gradient system 116 can compute gradients of an objective function with respect to the set of neural network parameters of the neural network, and then add noise to the gradients. The worker computing unit can then aggregate the gradients associated with each training example to form the noisy gradient 118, and then provide the noisy gradient 118 for use by the training system in updating the current values of the set of neural network parameters stored in the central memory 104.

However, adding noise to each of the gradient values can reduce the training speed of the neural network 112 because doing so would require the worker computing units 102 to send relatively large amounts of data to the central memory 104. For example, a gradient computed for a training example may be originally sparse (and can thus be compactly represented by a small amount of data) because the gradient values included in the gradient may be non-zero only for those embedding layer parameters defining embeddings of categorical feature values included in the network input of the training example.

Adding noise to each of the gradient values (e.g., as part of generating the noisy gradient 118) can cause the gradients to become dense, as gradient values that were originally zero may be adjusted to non-zero values by added noise. An increased density in the gradients can increase latency in transmitting gradients to the central memory 104 due to the increased amount of data required to represent the gradients, which can slow down the training speed of the neural network 112 and result in decreased efficiency during training.

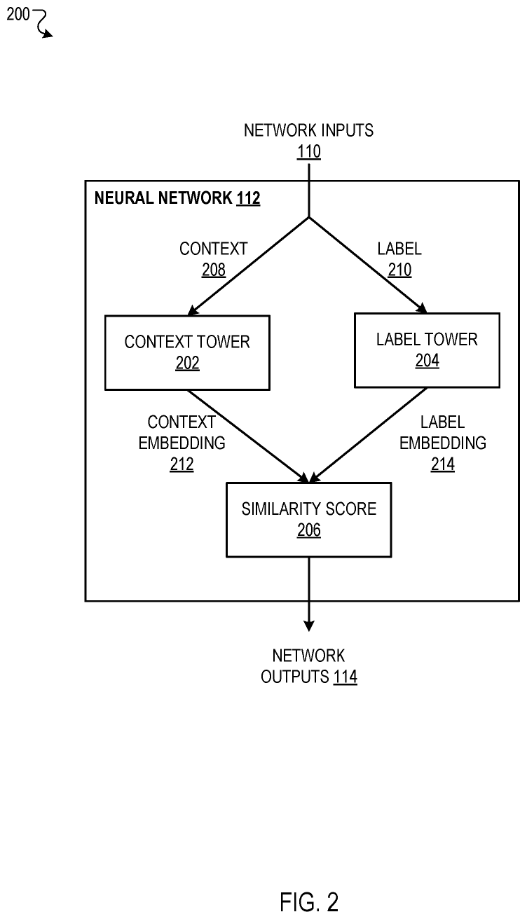

As such, the gradient system 116 can be configured to generate the noisy gradient 118 in a manner than encourages sparsity of the noisy gradient (even after the addition of noise) in order to increase the efficiency of training, and reduce the resource overhead required by the neural network, for example memory capacity, processor cycles, bus utilization. For instance, the gradient system 116 can combine random noise with selected subsets of gradient values in order to generate the noisy gradient, as will be described in more detail below with reference to FIG. 2-FIG. 6.

After the training system completes the training of the neural network, the training system can provide the trained neural network for deployment, e.g., in a data center or on a user device.

FIG. 2 shows an example architecture of a neural network 112, e.g., that is trained by the training system described with reference to FIG. 1.

The system can use the neural network 112 can process network inputs 110 that include sparse categorical features with large vocabularies to generate a prediction (e.g., a recommendation).

The network inputs 110 can include context and label pairs (e.g., a context 208 and a corresponding label 210). The context 208 can include feature values of a categorical feature that characterize one or more previous entities interacted by a user, e.g., previous search queries of a user, previous digital components interacted with by the user, previous videos watched by the user, etc.

For example, the context 208 can be a sequence of previous videos a user has watched, and the label 210 can be the next film for the user to watch. In some other examples, the context 208 can be tokens (e.g., categorical features) representing a sequence of text messages between a first user and a second user.

The neural network 112 is configured to generate a network output that characterizes a predicted next entity interacted with by the user in the form of a similarity score 206. In particular, the similarity score 206 characterizes a likelihood that a categorical feature value included in the label 210 represents a next entity (e.g., a next search query) interacted with by the user.

The neural network 112 includes a context tower 202 and a label tower 204. In this case, the embedding-based neural network 112 can use the context tower 202 and the label tower 204 to generate embeddings that represent the network inputs 110 as continuous vectors.

The neural network 112 can generate a similarity score 206 for multiple possible labels 210, and the neural network 112 can select the predicted label 210 by comparing the similarity scores of the multiple possible labels 210. In some examples, the neural network 112 can use the similarity scores of the multiple possible labels 210 to optimize a loss function and to enforce positive examples, as described in more detail below.

The context tower 202 and the label tower 204 are encoder neural networks, such as fully-connected neural networks, convolutional neural networks, or Transformers. The context tower 202 and the label tower 204 each include a respective embedding layer that generates a context embedding 212 and a label embedding 214, respectively. Optionally, the context tower and the label tower 204 can each include one or more additional neural network layers.

In particular, the context tower 202 processes a context 208 to encode (e.g., generate) the context embedding 212 that represents the context 208, and the label tower 204 processes a label 210 to encode (e.g., generate) the label embedding 214 that represents the label 210.

The neural network 112 can process the context embedding 212 and the label embedding 214 to generate a similarity score 206. The neural network can generate the similarity score 206 as a measure of similarity between the context embedding 212 and the label embedding 214. The measure of similarity can be, e.g., a cosine similarity measure, an inner product similarity measure, an L₁ norm similarity measure, or any other appropriate similarity measure. The training system can train the neural network 112 to optimize a loss function. The loss function can encourage the neural network 112 to enforce positive examples (e.g., similar context and label pairs) with a high similarity score 206, and negative examples (e.g., dissimilar context and label pairs) with a low similarity score 206.

Once trained, the model can predict relevant items (e.g., network outputs 114) for network inputs 110 using current neural network parameters 106.

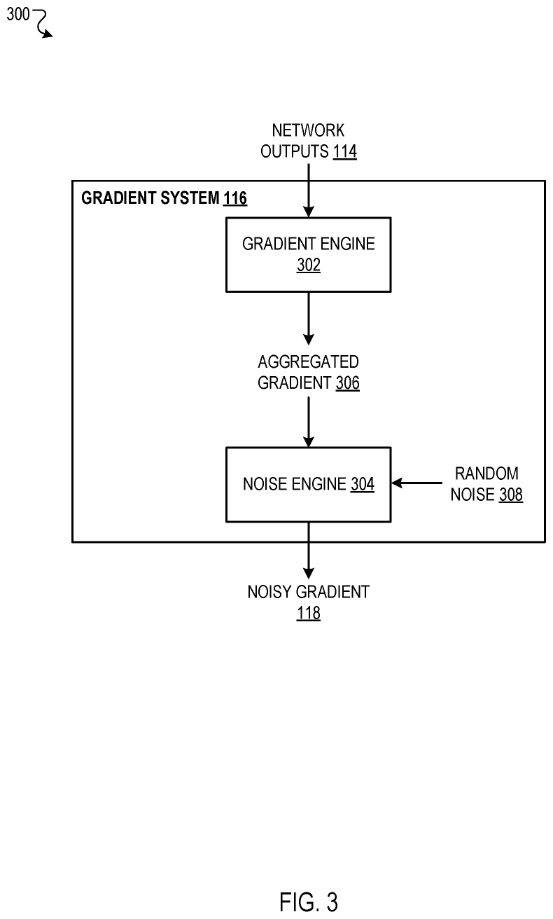

However, in some cases, the neural network 112 can be subject to a privacy attack that aims to extract information about the training data (e.g., the network inputs 110) to reveal individual network inputs, which can result in the exposure of confidential information. The risk of privacy attacks, if left unaddressed, can reduce security, which can limit the deployment of machine learning models that are trained on sensitive datasets. Thus, as described in more detail below with reference to FIGS. 3-6, the system can use privacy-sensitive, and more secure, training, e.g., by combining noise with gradients prior to using the gradients to update the set of neural network parameters.

FIG. 3 shows an example gradient system 300. The gradient system 300 is an example of a system implemented as computer programs on one or more computers in one or more locations in which the systems, components, and techniques described below are implemented. For instance, the gradient system 116 can be implemented by a worker computing unit of a training system, e.g., training system 100, as described above with reference to FIG. 1.

The gradient system 116 is configured to perform privacy-sensitive training by generating a noisy gradient 118 by processing network outputs 114.

The gradient system 116 includes a gradient engine 302 and a noise engine 304, which are each described in more detail next.

The gradient engine 302 is configured to process the network outputs 114 to generate the aggregated gradient 306. The gradient engine 302 can determine the aggregated gradient 306 by computing the gradients of the network outputs 114.

In particular, the gradient engine 302 can compute a gradient for each of the network outputs 114 by determining a gradient of an objective function with respect to the neural network parameters 106 when the objective function is evaluated on the network output 114. The gradient engine 302 can generate a gradient of the objective function when evaluated on a network output, e.g., by backpropagating the gradient of the objective function through the neural network parameters 106.

The objective function can be a real-valued loss function whose value is to be minimized or maximized subject to constraints of the function. The gradient engine 302 can determine the gradient of the objective function by minimizing a value of the loss function with respect to the neural network parameters 106. For example, the objective function can be a linear loss function or a softmax loss function or a cross-entropy loss function or a squared-error loss function.

The gradient engine 302 can clip the gradient of each network output 114 based on a predefined clipping threshold. In particular, the gradient engine 302 can scale the gradient to cause a norm of the gradient to satisfy the predefined clipping threshold.

The gradient engine 302 then combines the gradients of each of the network outputs 114 to generate the aggregated gradient 306, e.g., by calculating an average of the gradients. The aggregated gradient 306 can be a sparse array of numerical values. In particular, the aggregated gradient 306 can be sparse because the aggregated gradient 306 includes non-zero values corresponding to embedding layer parameters, where the embedding layer parameters define embeddings that correspond to a set of categorical feature values of a network input (e.g., a context 208). In some examples, the aggregated gradient 306 includes values corresponding to non-embedding layer parameters that may not be sparse.

The noise engine 304 is configured to process the aggregated gradient 306 and random noise 308 to generate the noisy gradient 118. The noise engine 304 can identify a subset of the gradient values included in the aggregated gradient 306 as target gradient values. The target gradient values can include non-zero gradient values corresponding to embedding layer parameters of the neural network 112, and, optionally, the target gradient values can include gradient values corresponding to non-embedding layer parameters of the neural network 112.

The noise engine 304 can combine random noise 308 with the target gradient values to generate the noisy gradient 118. The system can sample the random noise 308 from a predefined probability distribution (e.g., a zero mean Gaussian distribution or a uniform distribution). The noise engine 304 can combine random noise 308 with the target gradient values to generate the noisy gradient 118. For example, the noise engine 304 can generate the noisy gradient 118 by adding random noise 308, multiplying random noise 308, or a combination thereof. The noisy gradient 118 can be a sparse array of numerical values, and the system can use the noisy gradient 118 to protect privacy of information of the network outputs 114 and to increase the efficiency of training the neural network 112.

The system can then update the values of the neural network parameters 106 stored in the central memory 104 using the noisy gradient 118. The system updates current values of the neural network parameters 106 using a gradient descent update rule from a gradient descent optimization algorithm, e.g., RMSprop or Adam.

Adding random noise 308 to the target gradient values can keep the noisy gradient 118 values sparse while maintaining the privacy of the input data of the network outputs 114 corresponding to the target gradient values. In particular, by adding random noise 308, the system preserves the privacy of a user's selections based on the non-zero values of the gradients, and by keeping the values of the embeddings sparse, the system can improve the overall training speed of the neural network 112.

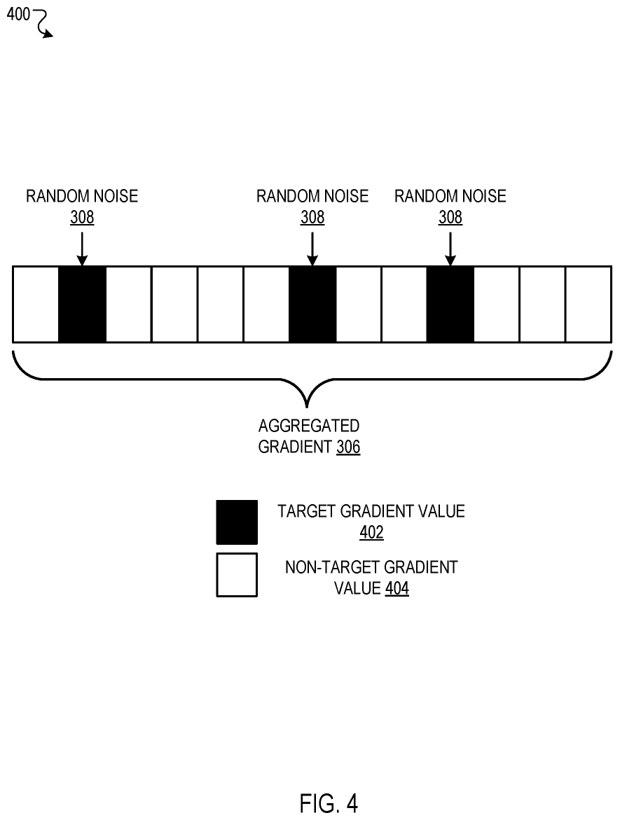

FIG. 4 illustrates an array of gradient values for an aggregated gradient and demonstrates random noise insertion. The array 400 is an example of an array generated by a worker computing unit, e.g., of the training system 100 described above with reference to FIG. 1

The array 400 includes the aggregated gradient 306. The aggregated gradient 306 is an average of the gradients corresponding to the network inputs.

The system can selectively add random noise 308 to certain gradient values of the aggregated gradient 306. In particular, the system can add random noise 308 to the target gradient values 402, and the system can refrain from adding random noise 308 to non-target gradient values 404.

Adding random noise 308 to the target gradient values can keep the noisy gradient 118 values sparse while maintaining the privacy of the input data of the network outputs 114 corresponding to the target gradient values. In particular, by adding random noise 308, the system preserves the privacy of a user's selections based on the non-zero values of the gradients, and by keeping the values of the embeddings sparse, the system can improve the overall training speed of the neural network 112.

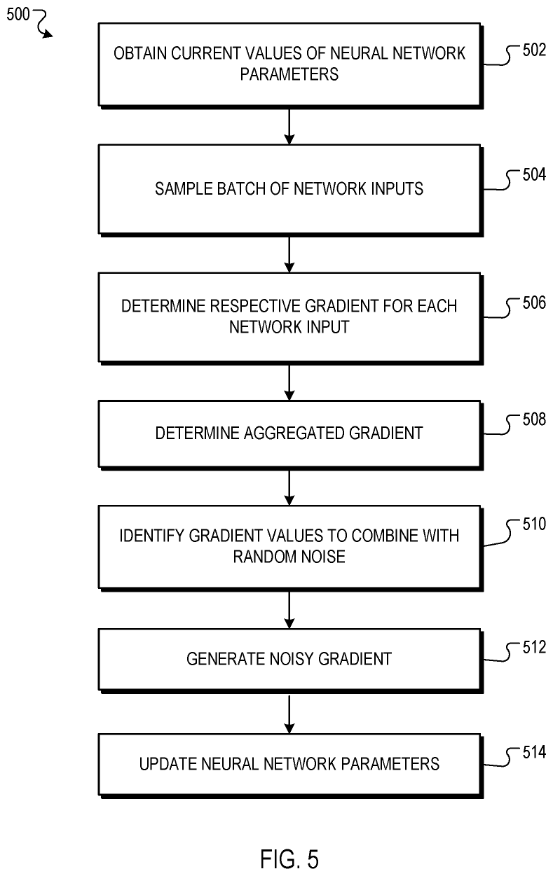

FIG. 5 shows a flow diagram of an example process 500 for privacy-sensitive training of a neural network having a set of neural network parameters. For convenience, the process 500 will be described as being performed by one or more worker computing units. For example, a worker computing unit, e.g., the worker computing unit 102 of FIG. 1, appropriately configured in accordance with this specification, can perform the process 500.

The system obtains current values of neural network parameters (502). For example, the system can obtain the current values of the neural network parameters 106 from the central memory 104.

The system then samples a batch of network inputs (504). For example, the worker computing unit 102 includes a set of training data 108, and the worker computing unit 102 can obtain a sample of training examples (e.g., network inputs 110) from the training data 108 by randomly sampling from the training data 108.

The system determines a respective gradient for each network input (506). For example, for each network input 110, the worker computing unit 102 can process the network input using the neural network 112 using the neural network parameters 106 to generate a network output 114. The worker computing unit 102 can then determine a gradient of an objective function with respect to the set of neural network parameters 106 when the objective function is evaluated on the network output.

The system then determines an aggregated gradient (508). For example, the worker computing unit 102 combines (e.g., averages) each gradient corresponding to each network output 114 to generate the aggregated gradient, which can be a sparse array of gradient values.

The system identifies gradient values to combine with random noise (510). For example, the worker computing unit 102 uses the gradient system 116 to select to add random noise to certain gradient values (e.g., target gradient values) of the aggregated gradient.

The system then generates a noisy gradient (512). For example, the worker computing unit 102 generates the noisy gradient 118 by adding the random noise to the target gradient values.

The system then updates neural network parameters (514). For example, the worker computing unit 102 updates the neural network parameters 106 included in the central memory 104 based on the noisy gradient 118 to efficiently train the neural network 112 while maintaining user privacy.

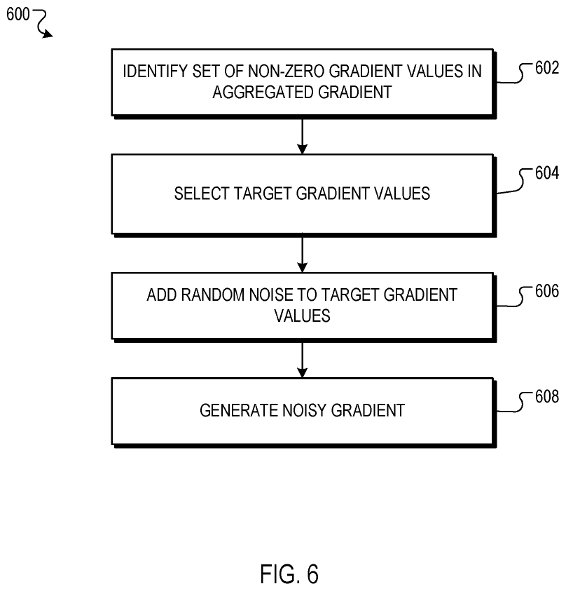

FIG. 6 shows a flow diagram of an example process for generating a noisy gradient from an aggregated gradient. For convenience, the process 600 will be described as being performed by one or more worker computing units. For example, a worker computing unit, e.g., the worker computing unit 102 of FIG. 1, appropriately configured in accordance with this specification, can perform the process 600.

The system identifies a set of non-zero gradient values in the aggregated gradient (602). For example, the worker computing unit 102 identifies the gradient values in the aggregated gradient that are non-zero.

The system then selects target gradient values (604). For example, the worker computing unit 102 uses the gradient system 116 to select target gradient values to add random noise, where the target gradient values are the non-zero values.

The system adds random noise to the target gradient values (606). For example, the worker computing unit 102 uses the gradient system 116 to add random noise (e.g., Gaussian noise) to the target gradient values. The system adds the random noise to preserve privacy of the user data included in the gradient values.

The system then generates the noisy gradient (608). For example, the worker computing unit 102 generates the noisy gradient 118 which includes the aggregated gradient with added random noise of the non-zero gradient values.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible storage medium, which may be non-transitory, for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system for privacy-sensitive training of a neural network having a set of neural network parameters, the system comprising:
a central memory that is configured to store current values of the set of neural network parameters; and
one or more computers that are configured to implement a plurality of worker computing units, wherein each worker computing unit is configured to repeatedly perform operations comprising:
obtaining current values of the set of neural network parameters from the central memory;
sampling a batch of network inputs from a set of training data;
determining a respective gradient corresponding to each network input, comprising, for each network input:
processing the network input using the neural network, in accordance with current values of the set of neural network parameters, to generate a network output; and
determining a gradient of an objective function with respect to the set of neural network parameters when the objective function is evaluated on the network output;
determining an aggregated gradient based on the gradients corresponding to the network inputs;
identifying a proper subset of a set of gradient values included in the aggregated gradient as target gradient values to be combined with random noise;
generating a noisy gradient by combining random noise with the target gradient values in the aggregated gradient; and
updating the current values of the set of neural network parameters stored in the central memory using the noisy gradient.

2. The system of claim 1, wherein for each network input, determining the gradient corresponding to the network input comprises:
clipping the gradient corresponding to the network input based on a predefined clipping threshold.

3. The system of claim 2, wherein for each network input, clipping the gradient corresponding to the network input based on the predefined clipping threshold comprises:
scaling the gradient to cause a norm of the gradient to satisfy the predefined clipping threshold.

4. The system of claim 1, wherein the aggregated gradient is defined by a sparse array of numerical values.

5. The system of claim 1, wherein the noisy gradient is defined by a sparse array of numerical values.

6. The system of claim 1, wherein identifying the proper subset of the set of gradient values included in the aggregated gradient as target gradient values to be combined with random noise comprises:
identifying a set of non-zero gradient values in the aggregated gradient; and
selecting a gradient value in the aggregated gradient as a target gradient value only if the gradient value is included in the set of non-zero gradient values in the aggregated gradient.

7. The system of claim 1, wherein generating the noisy gradient by combining random noise with the target gradient values in the aggregated gradient comprises, for each target gradient value in the aggregated gradient:
adding a respective random noise value to the target gradient value.

8. The system of claim 7, wherein the random noise value is sampled from a Gaussian distribution.

9. The system of claim 1, wherein determining the aggregated gradient based on the gradients corresponding to the network inputs comprises:
generating the aggregated gradient as an average of the gradients corresponding to the network inputs.

10. The system of claim 1, wherein for each network input, determining the gradient of the objective function with respect to the set of neural network parameters when the objective function is evaluated on the network output comprises:
backpropagating the gradient of the objective function through the set of neural network parameters.

11. The system of claim 1, wherein updating the current values of the set of neural network parameters stored in the central memory using the noisy gradient comprises:
updating the current values of the set of neural network parameters using the noisy gradient by a gradient descent update rule.

12. The system of claim 1, wherein the neural network is configured to receive a network input that includes features values of a categorical feature, wherein the set of neural network parameters define a respective embedding corresponding to each possible value of the categorical feature.

13. The system of claim 12, wherein the neural network comprises an embedding layer that is configured to map each categorical feature value included in the network input to a corresponding embedding.

14. The system of claim 12, wherein the categorical feature has at least 100,000 possible categorical feature values.

15. The system of claim 12, wherein the neural network is configured to receive a network input includes feature values of the categorical feature that characterize a previous search query of a user, and the neural network is configured to generate a network output that characterizes a predicted next search query of the user.

16. The system of claim 12, wherein the neural network is configured to receive a network input that includes feature values of the categorical feature that characterize previous videos watched by a user, and the neural network is configured to generate a network output that characterizes a predicted next video watched by the user.

17. The system of claim 12, wherein the neural network is configured to receive a network input that includes feature values of the categorical feature that characterize previous webpages visited by a user, and the neural network is configured to generate a network output that characterizes a predicted next webpage visited by the user.

18. The system of claim 12, wherein the neural network is configured to receive a network input that includes feature values of the categorical feature that characterizes previous products associated with a user, and the neural network is configured to generate a network output that characterizes a predicted next product associated with the user.

19. A method performed by one or more computers for privacy-sensitive training of a neural network having a set of neural network parameters, the method comprising:
repeatedly performing, by each of a plurality of worker computing units, operations comprising:
obtaining current values of the set of neural network parameters from a central memory;
sampling a batch of network inputs from a set of training data;
determining a respective gradient corresponding to each network input, comprising, for each network input:
processing the network input using the neural network, in accordance with current values of the set of neural network parameters, to generate a network output; and
determining a gradient of an objective function with respect to the set of neural network parameters when the objective function is evaluated on the network output;
determining an aggregated gradient based on the gradients corresponding to the network inputs;
identifying a proper subset of a set of gradient values included in the aggregated gradient as target gradient values to be combined with random noise;
generating a noisy gradient by combining random noise with the target gradient values in the aggregated gradient; and
updating the current values of the set of neural network parameters stored in the central memory using the noisy gradient.

20. One or more computer storage media storing instructions that when executed by one or more computers cause the one or more computers to perform operations for privacy-sensitive training of a neural network having a set of neural network parameters, the operations the operations comprising:
repeatedly performing, by each of a plurality of worker computing units, operations comprising:
obtaining current values of the set of neural network parameters from a central memory;
sampling a batch of network inputs from a set of training data;
determining a respective gradient corresponding to each network input, comprising, for each network input:
processing the network input using the neural network, in accordance with current values of the set of neural network parameters, to generate a network output; and
determining a gradient of an objective function with respect to the set of neural network parameters when the objective function is evaluated on the network output;
determining an aggregated gradient based on the gradients corresponding to the network inputs;
identifying a proper subset of a set of gradient values included in the aggregated gradient as target gradient values to be combined with random noise;
generating a noisy gradient by combining random noise with the target gradient values in the aggregated gradient; and
updating the current values of the set of neural network parameters stored in the central memory using the noisy gradient.
